(19) United States
(12) Patent Application Publication
(10) Pub. No.: US 2025/0354438 A1
(43) Pub. Date: Nov. 20, 2025

(54) One-Piece Screen Support Frame

(71) Applicant: ILPEA Industries Inc., Scottsburg, IN (US)

(72) Inventors: Michael JACKSON, Nabb, IN (US); Riccardo Gabaldo, New Albany, IN (US)

(73) Assignee: ILPEA Industries Inc., Scottsburg, IN (US)

(21) Appl. No.: 19/290,947

(22) Filed: Aug. 5, 2025

Related U.S. Application Data
(63) Continuation-in-part of application No. 17/875,635, filed on Jul. 28, 2022.

(51) Int. Cl. E06B 9/52

(52) U.S. Cl. CPC E06B 9/52; E06B 2009/527

(57) ABSTRACT

A screen support frame element includes a base having a base body and a first leg and a second leg. The first leg includes a first barb and the second leg includes a second barb. A cover includes a lip and an arm. The arm includes a first flange that extends towards the lip. An integrated spline has a spline body extending between a first spline end and a second spline end having a spline protrusion. The cover is movable such that the first flange engages the first barb, and the lip extends over and is decoupled from the second leg, the integrated spline is movable such that the spline protrusion engages the second barb The base, and integrated spline are integrated as a single piece.

### CROSS-REFERENCE TO RELATED APPLICATIONS

This application is a continuation-in-part of U.S. patent application Ser. No. 17/875,635 filed on Jul. 28, 2022. The entire disclosure of the above application is incorporated herein by reference.

### FIELD

The present disclosure relates to screen systems and, more particularly, to a one-piece screen support frame.

### BACKGROUND

This section provides background information related to the present disclosure which is not necessarily prior art.

A screen attachment assembly is used to enclose an opening with a screen. Often, screen attachment assemblies include a plurality of components that must be assembled in a particular order and configuration. For example, the screen attachment assembly may include a cover, a base, and a spline as separate components and require tools to insert the spline into the base. However, handling the plurality of components of the screen attachment assembly and the use of tools results in a labor intensive and cumbersome process for an installer.

The present disclosure provides a one-piece screen support frame that minimizes the number of components and tools required to enclose the opening with the screen. Accordingly, the present disclosure allows for a more efficient and streamlined process for the installer.

### SUMMARY

This section provides a general summary of the disclosure and is not a comprehensive disclosure of its full scope or all of its features.

A screen support frame element, in accordance with the present disclosure, includes a base extending between a first base end and a second base end. The base includes a base body and a first leg and a second leg extending from the base body. The first leg includes a first barb and the second leg includes a second barb. A cover includes a first cover end, a second cover end, an inner surface, and an outer surface. The cover includes a lip extending from the cover body at the second cover end, and an arm extending from the inner surface of the cover between the first cover end and the lip. The arm includes a first flange that extends towards the lip. An integrated spline has a spline body extending between a first spline end and a second spline end having a spline protrusion. The first spline end is connected to the first leg through a spline hinge. The cover is movable between an open cover position and a closed cover position such that the first flange engages the first barb, and the lip extends over and is decoupled from the second leg, the integrated spline is movable relative to the base between an open spline position and a closed spline position such that the integrated spline is positioned below the cover and the spline protrusion engages the second barb when the integrated spline is in the closed spline position, and the base, and integrated spline are integrated as a single piece.

In other features, the integrated spline includes a circular formation extending from the spline body.

In other features, the base includes a third leg extending from the base body between the first leg and the second leg, the circular formation being configured to engage the third leg when the integrated spline is in the closed spline position.

In other features, a screen is positioned between the lip and the third leg when the cover is in the closed cover position.

In other features, the screen extends between the circular formation and the third leg with the integrated spline is in the closed spline position.

In other features, the spline protrusion and the circular formation are positioned on opposite sides of the spline body.

In other features, the base includes a cover support leg, the cover is pivotally connected to the cover support leg through a cover hinge, each of the cover hinge and the spline hinge being one of a flexible hinge and a living hinge.

In other features, the cover hinge and the spline hinge are integrally formed with the base.

In other features, the base, the cover, and the integrated spline are formed from a first material and the cover hinge, and the spline hinge are formed from a second material that is distinct from the first material.

In other features, the integrate spline includes a V-shaped notch defined between the second spline end and the spline protrusion.

In other features, the V-shaped notch includes an apex having a rounded surface.

A screen support frame element, in accordance with the present disclosure, includes a base extending between a first base end and a second base end. The base includes a base body and a first leg, a second leg, a third leg, and a fourth leg extending from the base body. The first leg includes a first barb, the second leg includes a second barb, the third leg includes a third barb, and the fourth leg includes a fourth barb. A first integrated spline has a first spline body extending between a first spline end and a second spline end having a first spline protrusion. The first spline end is connected to the first leg through a first spline hinge. A second integrated spline has a second spline body extending between a third spline end and a fourth spline end having a second spline protrusion. The third spline end is connected to the third leg through a second spline hinge. A cover has a cover body including a first cover end, a second cover end, an inner surface, and an outer surface. The cover includes a first lip extending from the cover body at the first cover end and a second lip extending from the cover body at second cover end, a first arm extending from the inner surface of the cover and a second arm extending from the inner surface. The first arm includes a first flange that extends towards the first leg and the second arm includes a second flange that extends toward the third leg. The cover is movable between an open position and a closed position such that the first flange engages the first barb, the second flange engages the fourth barb, the first lip extends over and is decoupled from the second leg, and the second lip extends over and is decoupled from the fourth leg. The first integrated spline is movable relative to the base between a first open spline position and a first closed spline position such that the first integrated spline is positioned below the cover and the first spline protrusion engages the second barb when the first integrated spline is in the first closed spline position. The second integrated spline is movable relative to the base between a second open spline position and a second closed spline position such that the second integrated spline is positioned below the cover and the second spline protrusion engages the fourth barb when the second integrated spline is in the second closed spline position. The base, and integrated spline are integrated as a single piece.

In other features, the first spline hinge and the second spline hinge comprise one of a flexible hinge and a living hinge.

In other features, the first spline hinge and the second spline hinge comprise a first flexible hinge and a second flexible hinge formed from a flexible material including one of flexible polyvinyl chloride (PVC), santoprene, and polypropylene.

In other features, the first integrated spline includes a first circular formation extending from the first spline body between the second spline end and the first spline protrusion and the second integrated spline includes a second circular formation extending from the spline body between the fourth spline end and the second spline protrusion.

In other features, the base includes a fifth leg extending from the base body between the first leg and the second leg, and a sixth leg extending from the spline body between the third leg and the fourth leg, the first circular formation being configured to engage the fifth leg when the first integrated spline is in the first closed spline position, and the second circular formation being configured to engage the sixth leg when the second integrated spline is in the second closed spline position.

In other features, the first integrated spline is moveable between the first open spline position and the first closed spline position independently of movement of the second integrated spline between the second open spline position and the second closed spline position.

In other features, the first integrate spline includes a first V-shaped notch defined between the second spline end and the first spline protrusion and the second integrated spline includes a second V-shaped notch defined between the fourth spline end and the second spline protrusion.

In other features, the first V-shaped notch includes a first apex having a first rounded surface and the second V-shaped notch includes a second apex having a second rounded surface.

In other features, the cover is detachable from the base.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a portion of a porch enclosed with a plurality of one-piece screen support frames, according to the principles of the present disclosure;

FIG. 2 is a partial perspective view of the one-piece screen support frame of FIG. 1 depicting a cover in an open cover configuration and an integrated spline in an open spline configuration, in accordance with the present disclosure;

FIG. 3 is a side view of the one-piece screen support frame of FIG. 2, in accordance with the present disclosure;

FIG. 4 is a side view of the one-piece screen support frame of FIG. 3 showing an integrated spline being moved to a closed spline position, in accordance with the present disclosure;

FIG. 5 is a side view of the one-piece screen support frame of FIG. 2 in a closed cover configuration;

FIG. 6 is a partial perspective view of the one-piece screen support frame of FIG. of FIG. 5;

FIG. 7 is a disassembled view of a one-piece screen support frame, including a detachable cover, in accordance with the present disclosure;

FIG. 8 is a side view of the one-piece screen support frame of FIG. 7, in accordance with the present disclosure;

FIG. 9 is a side view of the one-piece screen support frame of FIG. 7 depicting first and second integrated splines in a closed spline configuration, in accordance with the present disclosure; and

FIG. 10 is a side view of the one-piece screen support frame of FIG. 7 depicting the first and second integrated splines in a closed spline configuration and the detachable cover in a closed cover configuration, in accordance with the present disclosure.

Corresponding reference numerals indicate corresponding parts throughout the several views of the drawings.

### DETAILED DESCRIPTION

Example embodiments will now be described more fully with reference to the accompanying drawings.

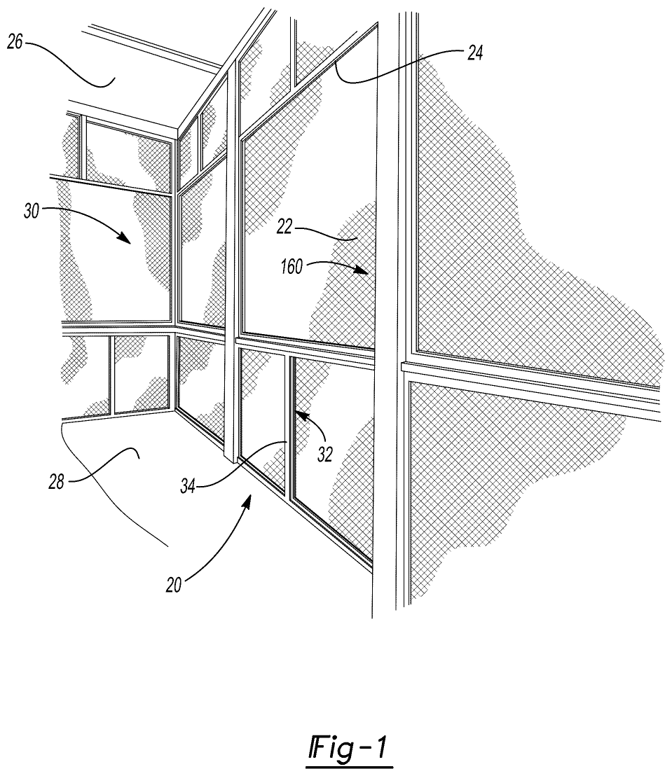

With reference to FIG. 1, one or more screen attachment assemblies 20 may be provided to secure one or more screens 22 to an opening 24. In some example embodiments and as shown in FIG. 1, one or more screen attachment assemblies 20 may secure the screen 22 to an opening 24 between a ceiling 26 and a floor 28 to define a screened wall 30. In other example embodiments, one or more screen attachment assemblies 20 may secure the screen 22 to an opening within a wall to define a screened window (not shown). In yet another example embodiment, one or more screen attachment assemblies 20 may secure the screen 22 to an opening in a door to define a screened door (not shown). Thus, it should be understood that the particular application of the one or more screen attachment assemblies 20 may vary and need not be limited to screened walls, screened doors, or screened windows.

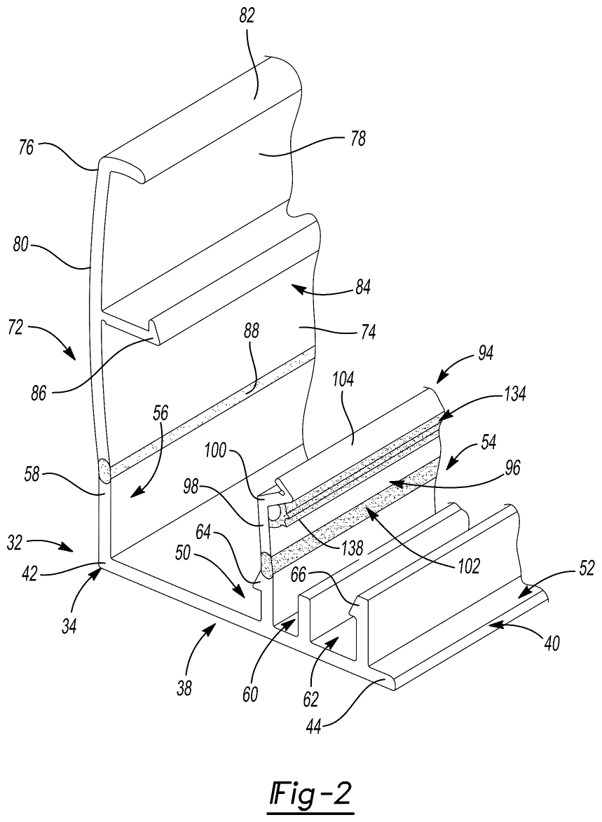

Referring to FIGS. 2-6, each screen attachment assembly 20 may include a screen support frame 32 formed from a plurality of screen support frame elements 34. Each of the plurality of screen support frame elements 34 includes a base 38 having a base body 40 including a first base end 42 and a second base end 44.

A first leg 50 extends outwardly from base body 40 between first base end 42 and second base end 44. A second leg 52 extends outwardly from base body 40 adjacent to second base end 44. A third leg 54 extends outwardly from base body 40 between first leg 50 and second leg 52. A fourth leg 56, which forms a cover support leg 58 extends outwardly from base body 40 at first base end 42. A first screen cavity 60 is defined between first leg 50 and third leg 54 and a second screen cavity 62 is defined between third leg 54 and second leg 52.

In one exemplary aspect of the present disclosure, first leg 50, second leg 52, third leg 54, and fourth leg 56 extend substantially perpendicularly from base body 40. In the non-limiting example shown, first leg 50 includes a first barb 64 that extends toward cover support leg 58 and second leg 52 includes a second barb 66 that extends toward first leg 50.

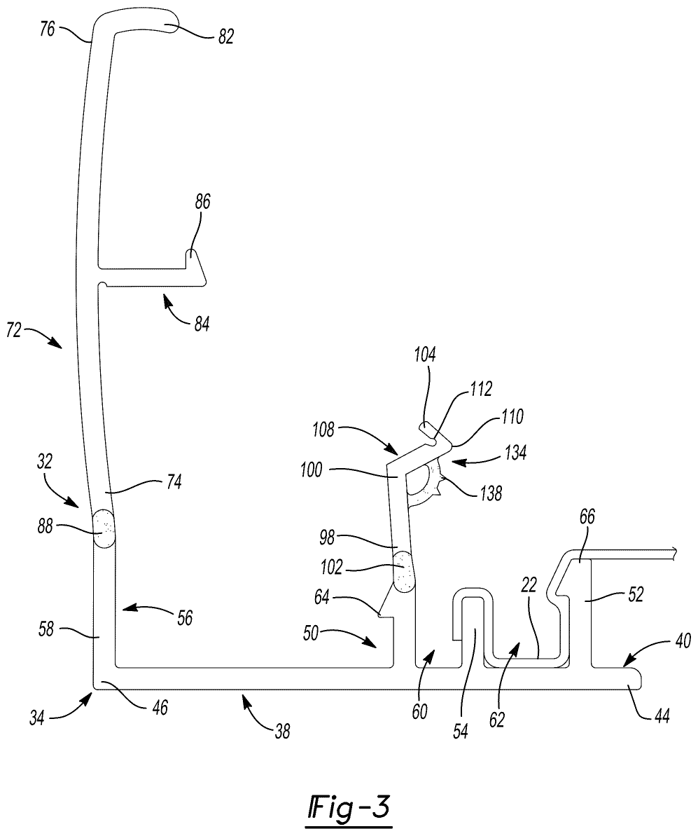

In an exemplary aspect illustrated in FIG. 3, first leg 50 extends from base body 40 a first distance, second leg 52 extends from base body 40 a second distance, third leg 54 extends from base body 40 a third distance, and fourth leg 56 extends from base body 40 a fourth distance. In accordance with an aspect of the disclosure, the fourth distance is greater than each of the first distance, the second distance, and the third distance. In one example, the third distance is less than the first distance and the second distance.

In accordance with an aspect of the disclosure, a cover 72 is pivotally attached to base 38. Cover 72 includes a first cover end 74 and a second cover end 76. Cover 72 also includes an inner surface 78 and an outer surface 80. Inner surface 78 and outer surface 80 extend between first cover end 74 and second cover end 76. Second cover end 76 includes a lip 82 that projects outwardly of inner surface 78. Cover 72 is also shown to include an arm 84 that projects outwardly of inner surface 78 between first cover end 74 and second cover end 76. Arm 84 includes a first flange 86. Cover 72 is pivotally connected to fourth leg 56 through a cover hinge 88.

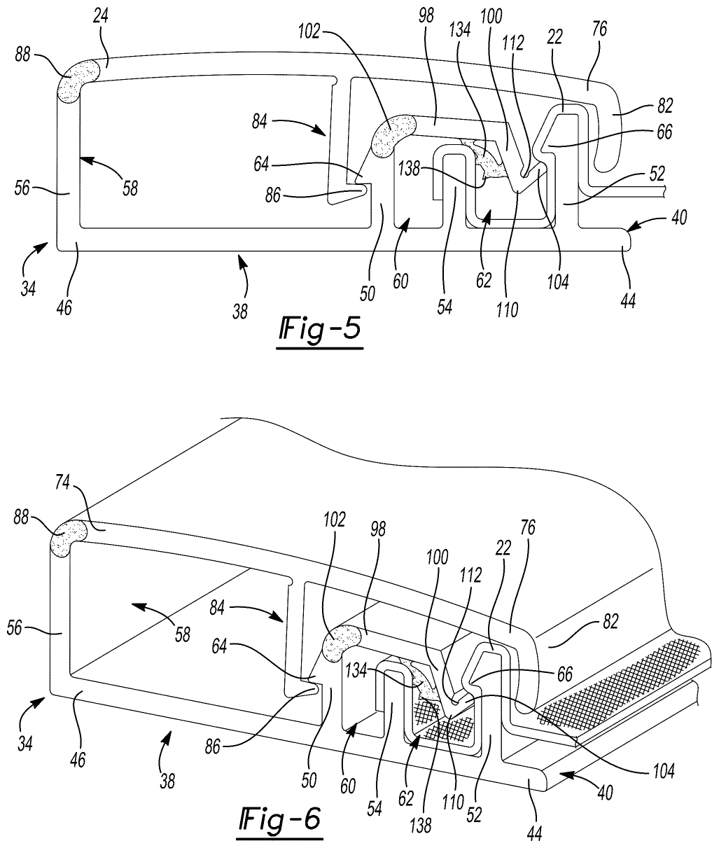

As will be detailed more fully herein, cover 72 may be movable between an open cover position (FIGS. 2-4) and a closed cover position (FIGS. 5-6) such that the screen 22 may be fixedly attached to screen support frame 32 when cover 72 is in the closed position. Accordingly, cover hinge 88 facilities a range of motion for cover 72. The range of motion may be greater than 90 degrees.

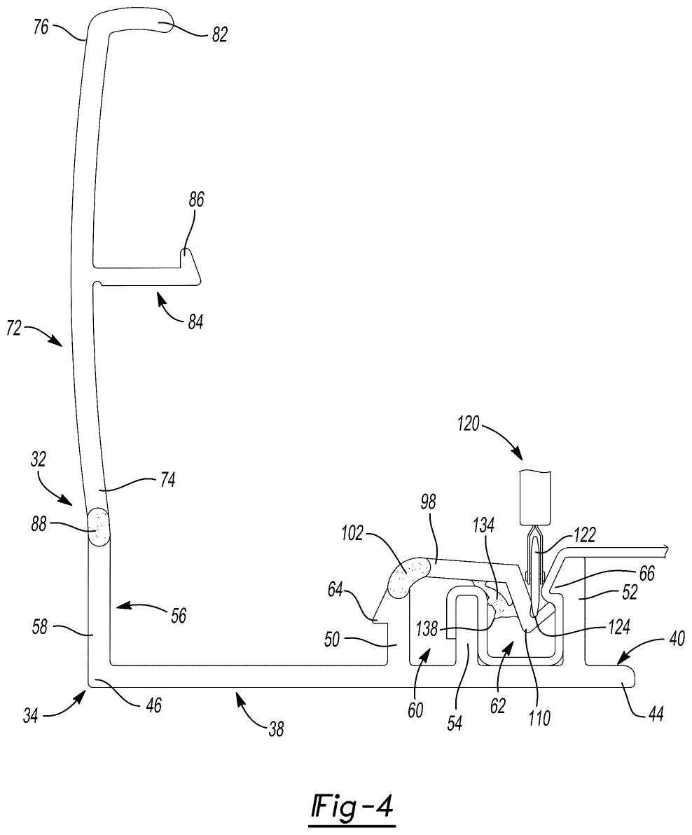

In accordance with an aspect of the present disclosure, each of the plurality of screen support frame elements 34 includes an integrated spline 94 that secures screen 22 to base 38. Integrated spline 94 includes a spline body 96 having a first spline end 98 and a second spline end 100. First spline end 98 is coupled to first leg 50 through a spline hinge 102. Spline hinge 102 accommodates rotation of integrated spline 94 between an open spline position (FIG. 3) and a closed spline position (FIG. 4). Second spline end 100 includes a spline protrusion 104 that is configured to engage with second barb 66 on second leg 52 when integrated spline 94 is in the closed spline position.

In accordance with an aspect of the present disclosure, integrated spline 94 includes a V-shaped notch 108 arranged at second spline end 100. V-shaped notch 108 is defined between second spline end 100 and spline protrusion 104. In accordance with an exemplary aspect, V-shaped notch 108 includes an apex 110 having a rounded surface 112. Rounded surface 112 provides a guide for a screen setting tool 120 to engage spline protrusion 104 with second barb 66 on second leg 52 as shown in FIGS. 5-6). Screen setting tool 120 includes a screen roller 122 having an outer edge 124 sized to fit into apex 110 with rounded surface 112 guiding movement of the screen setting tool 120 when securing screen 22 to base 38.

In accordance with an aspect of the present disclosure, integrated spline 94 includes a circular formation 134 arranged adjacent to V-shaped notch 108 on an underside (not separately labeled) of spline body 96 as shown in FIG. 3. Circular formation 134 includes a plurality of resilient teeth 138 that are configured to apply pressure to screen 22 when integrated spline 94 is in the closed spline position.

In accordance with the present disclosure, base 38, cover 72, and integrated spline 94 are integrally formed as a single piece from a first material. Cover hinge 88 and spline hinge 102 are formed from a second material that is distinct from the first material. Cover hinge 88 and spline hinge 102 may be capable of withstanding a temperature of at least 120° F. and capable of allowing the cover 72 to move between the open cover position and the closed cover position for a number of repetitions, such as, for example, at least ten repetitions. Cover hinge 88 and spline hinge 102 may also be ultra-violet and salt resistant. Additionally, Cover hinge 88 and spline hinge 102 may be either formed as a flexible hinge or a living hinge. The flexible hinge may be composed of a flexible material including flexible polyvinyl chloride (PVC) and santoprene. The living hinge of the Cover hinge 88 and spline hinge 102 may be composed of a plastic material including polyvinyl chloride (PVC) and polypropylene.

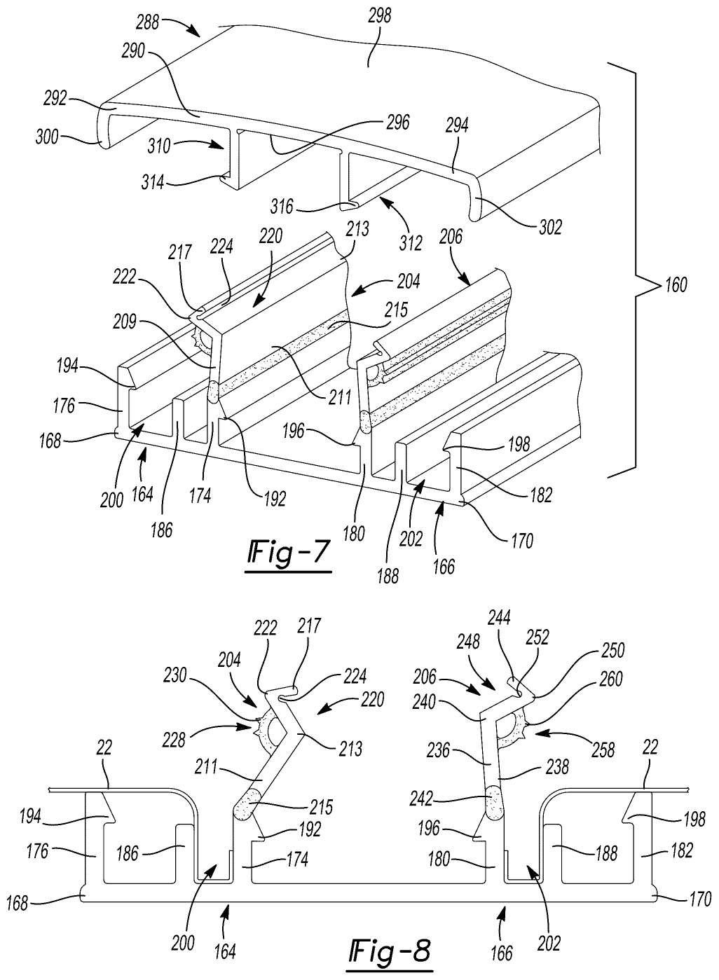

The operation of the screen support frame 32 will now be described. While cover 72 is in the open cover position and integrated spline 94 is in the open spline position (FIGS. 2-3), the screen 22 may be positioned along base 38 of support frame element 34. More specifically, screen 22 may be positioned above first leg 50, second leg 52, and third leg 54. Integrated spline 94 may be moved from the open spline position (FIGS. 6-7) to the closed spline position (FIGS. 4-6) using a single hand and/or by running screen setting tool 120 along V-shaped notch 108.

Accordingly, screen 22 may be inserted into the second screen cavity 62. In other words, screen 22 may be positioned between the second leg 52, third leg 54. With integrated spline 94 in the closed spline position, the plurality of resilient teeth 138 of the circular formation 134 urge screen 22 into second screen cavity 62. Additionally, spline protrusion 104 of integrated spline 94 may snap-fittingly engage with second barb 66 on second leg 52. In this configuration, screen 22 may be secured to the screen support frame 32.

Screen support frame 32 may be attached to another component (i.e., a wooden stud, a window frame, a door, etc.) using one or more mechanical fasteners (not shown) that is inserted through base body 40 between cover support leg 58 and first leg 50. At this point, cover 72 may then be moved to the closed cover position (FIGS. 5-6) with first flange 86 engaging with first barb 64 on first leg 50 with lip 82 being decoupled from base 38. By decoupling lip 82 from base 38, any pressure applied to screen 22 will not be passed into cover 72 resulting in undesirable movement to the open cover position.

Reference will now follow to FIGS. 7-10 in describing a screen support frame element 160 in accordance with another non-limiting example. Screen support frame element 160 may serve as a central support (not separately labeled) in screen support frame 32. The central support allows the screen support frame 32 to span larger openings 24 without the need for additional wood or supporting structure.

Screen support frame element 160 includes a base 164 having a base body 166 including a first base end 168 spaced from a second base end 170. Base 164 includes a first leg 174, a second leg 176, a third leg 180, and a fourth leg 182. Second leg 176 is arranged adjacent to first base end 168 and fourth leg 182 is arranged adjacent to second base end 170. First leg 174 and third leg 180 are arranged between second leg 176 and fourth leg 182. Base 164 is also shown to include a fifth leg 186 arranged between first leg 174 and second leg 176 and a sixth leg 188 arranged between third leg 180 and fourth leg 182. First leg 174, second leg 176, third leg 180, fourth leg 182, fifth leg 186, and sixth leg 188 extend substantially perpendicularly from base body 166 in accordance with one exemplary aspect.

In accordance with an exemplary aspect, first leg 174 includes a first barb 192 and second leg 176 includes a second barb 194. First barb 192 and second barb 194 face a central portion (not separately labeled) of base body 166. Third leg 180 includes a third barb 196 and fourth leg 182 includes a fourth barb 198. In a manner similar to that described herein, third barb 196 and fourth barb 198 face the central portion of base body 166. A first screen cavity 200 is defined between first leg 174 and fifth leg 186 and a second screen cavity 202 is defined between third leg 180 and sixth leg 188.

A first integrated spline 204 is connected to base body 166 at first leg 174 and a second integrated spline 206 is connected to base body 166 at third leg 180. Base 164, first integrated spline 204, and second integrated spline 206 are integrally formed. First integrated spline 204 includes a first spline body 209 having a first spline end 211 and a second spline end 213. First spline end 211 is connected to first leg 172 through a first spline hinge 215. Second spline end 213 includes a first spline protrusion 217.

In a manner similar to that discussed herein, a first V-shaped notch 220 having a first apex 222 is formed in first spline body 209 between second spline end 213 and first spline protrusion 217. First apex 222 includes a rounded surface 224 that can accommodate screen setting tool 120. First integrated spline 204 also includes a first circular formation 228 having a first plurality of resilient teeth 230 arranged between second spline end 213 and first V-shaped notch 220.

In accordance with the present disclosure, second integrated spline 206 includes a second spline body 236 having a third spline end 238 and a fourth spline end 240. Third spline end 238 is pivotally connected to third leg 180 through a second spline hinge 242. Second integrated spline 206 also includes a second spline protrusion 244 arranged at fourth spline end 240. In a manner similar to that discussed herein, a second V-shaped notch 248 having a second apex 250 is formed in second spline body 236 between fourth spline end 240 and second spline protrusion 244. Second apex 250 includes a second rounded surface 252 that can accommodate screen setting tool 120. Second integrated spline 206 also includes a second circular formation 258 having a second plurality of resilient teeth 260 arranged between second spline end 213 and first V-shaped notch 220.

In accordance with a non-limiting example, a cover 288 may be detachably connected to base 164. Cover 288 includes a cover body 290 having a first cover end 292 and a second cover end 294 between which spans an inner surface 296 and an outer surface 298. Cover 288 includes a first lip 300 extending from inner surface 296 at first cover end 292 and a second lip 302 extending from inner surface 296 at second cover end 294.

Cover 288 also includes a first arm 310 extending from inner surface 296 between first cover end 284 and second cover end 286 and a second arm 312 extending from inner surface 296 between first arm 310 and second cover end 286. First arm 310 includes a first flange 314 and second arm 312 includes a second flange 316. In an exemplary aspect, first flange 314 extends outwardly from first arm 310 toward first lip 300 and second flange 316 extends outwardly from second arm 312 towards second lip 302.

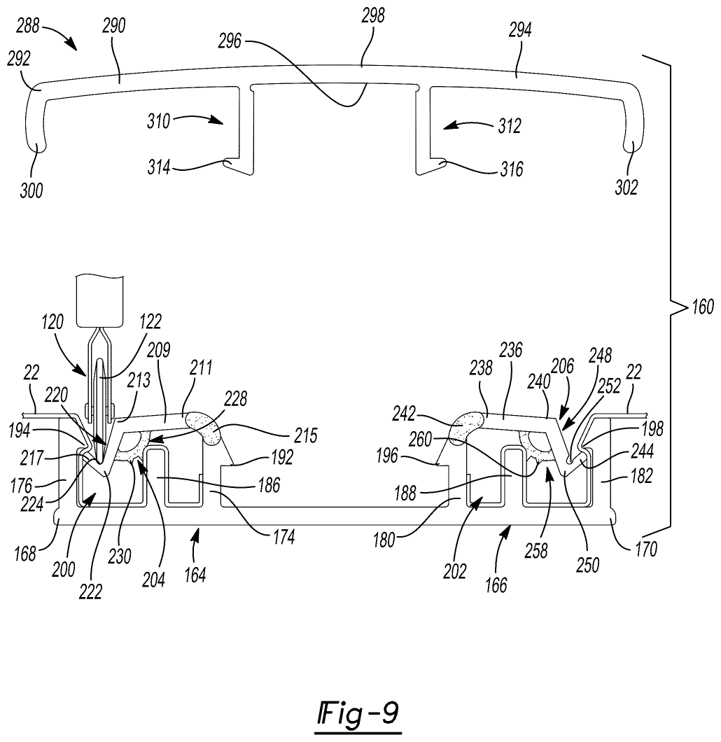

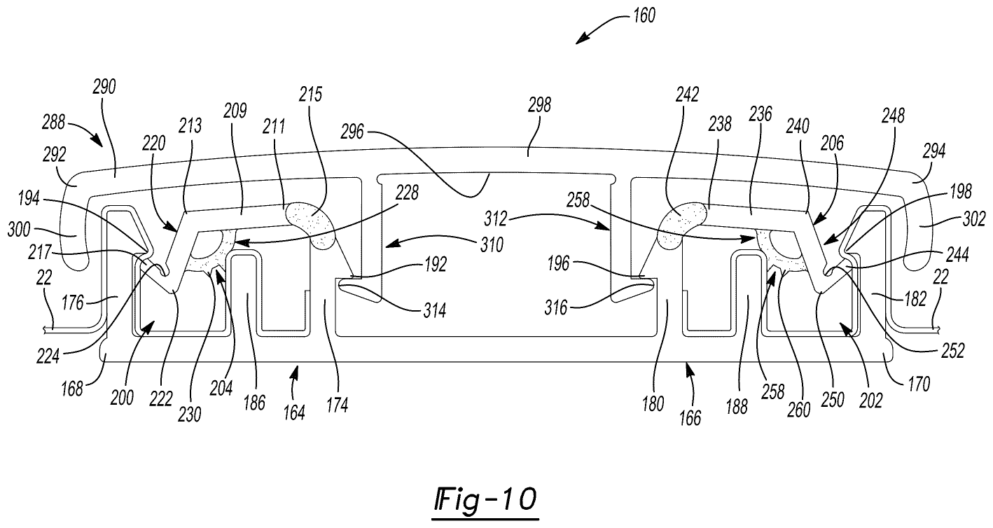

The operation of the screen support frame 32 having the screen support frame element 160 will now be described. While cover 288 is a detached cover position and first integrated spline 204 and second integrated spline 206 are in the open spline positions respectively, (FIGS. 7-8), a first screen 22 may be positioned along base 164 of screen support frame element 160. More specifically, first screen 22 may be positioned above first leg 174, second leg 176, and fifth leg 186. First integrated spline 204 may be moved from the open spline position (FIGS. 6-7) to the closed spline position (FIGS. 9-10) using a single hand and/or by running screen setting tool 120 along first V-shaped notch 220. First integrated spline 204 is moveable between the open spline position and the closed spline position independently of movement of the second integrated spline 206.

Accordingly, first screen 22 may be inserted into the first screen cavity 200. In other words, first screen 22 may be positioned between the first leg 174 and the fifth leg 186. With first integrated spline 204 in the first closed spline position, the first plurality of resilient teeth 230 of the first circular formation 228 urge second screen 22 into first screen cavity 200. Additionally, first spline protrusion 217 of first integrated spline 204 may snap-fittingly engage with second barb 194 on second leg 176. In this configuration, first screen 22 may be secured to the screen support frame 32.

Similarly, a second screen 22 may be positioned along base 164 of screen support frame element 160. More specifically, second screen 22 may be positioned above third leg 180, fourth leg 182, and sixth leg 188. Second integrated spline 206 may be moved from the open spline position (FIGS. 7-8) to the closed spline position (FIGS. 9-10) using a single hand and/or by running screen setting tool 120 along second V-shaped notch 246.

Accordingly, second screen 22 may be inserted into second screen cavity 202. In other words, second screen 22 may be positioned between the third leg 180, the fourth leg 182 and the sixth leg 188. With second integrated spline 206 in the closed spline position, the second plurality of resilient teeth 262 of the second circular formation 258 urge second screen 22 into second screen cavity 202. Additionally, second spline protrusion 244 of second integrated spline 206 may snap-fittingly engage with fourth barb 198 on fourth leg 182. In this configuration, second screen 22 may be secured to the screen support frame 32 adjacent to the first screen 22.

Screen support frame 32 may be attached to another component (i.e., a wooden stud, a window frame, a door, etc.) using one or more mechanical fasteners (not shown) that is inserted through base body 166 between, for example, first leg 174 and third leg 180. At this point, cover 288 may then be snap-fittingly engaged with base 164 with first flange 214 engaging second barb 194 and second flange 216 engaging fourth barb 198. When cover 288 is secured to base 164, first lip 300 and second lip 302 are decoupled from base body 166. By decoupling first lip 300 and second lip 302 from base body 166, any pressure applied to first and second screens 22 will not be passed into cover 288 resulting in undesirable detachment.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless defined otherwise, technical, and scientific terms used herein have the same meaning as is commonly understood by one of skill in the art to which this disclosure belongs.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A screen support frame element comprising:
a base extending between a first base end and a second base end, the base including a base body and a first leg and a second leg extending from the base body, the first leg including a first barb and the second leg including a second barb;
a cover including a cover body having a first cover end, a second cover end, an inner surface, and an outer surface, the cover including a lip extending from the cover body at the second cover end, and an arm extending from the inner surface of the cover between the first cover end and the lip, the arm including a first flange that extends towards the lip; and
an integrated spline having a spline body extending between a first spline end and a second spline end having a spline protrusion, the first spline end being connected to the first leg through a spline hinge,
wherein the cover is movable between an open cover position and a closed cover position such that the first flange engages the first barb, and the lip extends over and is decoupled from the second leg,
wherein the integrated spline is movable relative to the base between an open spline position and a closed spline position such that the integrated spline is positioned below the cover and the spline protrusion engages the second barb when the integrated spline is in the closed spline position, and
wherein the base, and integrated spline are integrated as a single piece.

2. The screen support frame element of claim 1, wherein the integrated spline includes a circular formation extending from the spline body.

3. The screen support frame element of claim 2, wherein the base includes a third leg extending from the base body between the first leg and the second leg, the circular formation being configured to engage the third leg when the integrated spline is in the closed spline position.

4. The screen support frame element of claim 3, further comprising a screen positioned between the lip and the third leg when the cover is in the closed cover position.

5. The screen support frame element of claim 4, wherein the screen extends between the circular formation and the third leg with the integrated spline is in the closed spline position.

6. The screen support frame element of claim 2, wherein the spline protrusion and the circular formation are positioned on opposite sides of the spline body.

7. The screen support frame element of claim 1, wherein the base includes a cover support leg, the cover is pivotally connected to the cover support leg through a cover hinge, each of the cover hinge and the spline hinge being one of a flexible hinge and a living hinge.

8. The screen support frame element of claim 7, wherein the cover hinge and the spline hinge are integrally formed with the base.

9. The screen support frame element of claim 8, wherein the base, the cover, and the integrated spline are formed from a first material and the cover hinge, and the spline hinge are formed from a second material that is distinct from the first material.

10. The screen support frame element of claim 1, wherein the integrate spline includes a V-shaped notch defined between the second spline end and the spline protrusion.

11. The screen support frame element according to claim 10, wherein the V-shaped notch includes an apex having a rounded surface.

12. A screen support frame element comprising:
a base extending between a first base end and a second base end, the base including a base body and a first leg, a second leg, a third leg, and a fourth leg extending from the base body, the first leg including a first barb, the second leg including a second barb, the third leg including a third barb, and the fourth leg including a fourth barb;
a first integrated spline having a first spline body extending between a first spline end and a second spline end having a first spline protrusion, the first spline end being connected to the first leg through a first spline hinge;
a second integrated spline having a second spline body extending between a third spline end and a fourth spline end having a second spline protrusion, the first spline end being connected to the third leg through a second spline hinge; and
a cover having a cover body including a first cover end, a second cover end, an inner surface, and an outer surface, the cover including a first lip extending from the cover body at the first cover end and a second lip extending from the cover body at second cover end, a first arm extending from the inner surface of the cover and a second arm extending from the inner surface, the first arm including a first flange that extends towards the first leg and the second arm including a second flange extending toward the third leg,
wherein the cover is movable between an open position and a closed position such that the first flange engages the first barb, the second flange engages the fourth barb, the first lip extends over and is decoupled from the second leg, and the second lip extends over and is decoupled from the fourth leg, and
wherein the first integrated spline is movable relative to the base between a first open spline position and a first closed spline position such that the first integrated spline is positioned below the cover and the first spline protrusion engages the second barb when the first integrated spline is in the first closed spline position,
wherein the second integrated spline is movable relative to the base between a second open spline position and a second closed spline position such that the second integrated spline is positioned below the cover and the second spline protrusion engages the fourth barb when the second integrated spline is in the second closed spline position, and
wherein the base, and integrated spline are integrated as a single piece.

13. The screen support frame element according to claim 12, wherein the first spline hinge and the second spline hinge comprise one of a flexible hinge and a living hinge.

14. The screen support frame element according to claim 13, wherein the first spline hinge and the second spline hinge comprise a first flexible hinge and a second flexible hinge formed from a flexible material including one of flexible polyvinyl chloride (PVC), santoprene, and polypropylene.

15. The screen support frame element of claim 12, wherein the first integrated spline includes a first circular formation extending from the first spline body between the second spline end and the first spline protrusion and the second integrated spline includes a second circular formation extending from the spline body between the fourth spline end and the second spline protrusion.

16. The screen support frame element of claim 15, wherein the base includes a fifth leg extending from the base body between the first leg and the second leg, and a sixth leg extending from the spline body between the third leg and the fourth leg, the first circular formation being configured to engage the fifth leg when the first integrated spline is in the first closed spline position, and the second circular formation being configured to engage the sixth leg when the second integrated spline is in the second closed spline position.

17. The screen support frame element according to claim 12, wherein the first integrated spline is moveable between the first open spline position and the first closed spline position independently of movement of the second integrated spline between the second open spline position and the second closed spline position.

18. The screen support frame element according to claim 12, wherein the first integrate spline includes a first V-shaped notch defined between the second spline end and the first spline protrusion and the second integrated spline includes a second V-shaped notch defined between the fourth spline end and the second spline protrusion.

19. The screen support frame element according to claim 18, wherein the first V-shaped notch includes a first apex having a first rounded surface and the second V-shaped notch includes a second apex having a second rounded surface.

20. The screen support frame element according to claim 12, wherein the cover is detachable from the base.
